(19) United States
(12) Patent Application Publication
(10) Pub. No.: US 2026/0154521 A1
(43) Pub. Date: Jun. 4, 2026

(54) METHODS AND PRINTING SYSTEM FOR USING OPTIMIZATION OPERATIONS IN PRINTING OPERATIONS

(71) Applicant: Kyocera Document Solutions Inc., Osaka (JP)

(72) Inventor: Javier A. MORALES, Rochester, NY (US)

(73) Assignee: Kyocera Document Solutions Inc., Osaka (JP)

(21) Appl. No.: 18/968,216

(22) Filed: Dec. 4, 2024

(51) Int. Cl. G06K 15/02

(52) U.S. Cl. CPC G06K 15/1822

(57) ABSTRACT

A printing system includes a printing device having a raster image processing (RIP) system. The printing device includes a controller to implement the RIP system. A manager of the RIP system configures RIP instances to process different levels of page complexity of a job. The RIP system evaluates the pages in the job to determine one or more pages that are complex. An optimization operation is selected to apply to a complex page to optimize the page to reduce rendering time in the RIP system. If the optimization operation is not effective, then the RIP system launches a configured RIP to render the complex page. A neural network model is trained to select the optimization operation.

### FIELD OF THE INVENTION

The present invention relates to a printing system and associated methods to optimize printing operations based on page complexity.

### DESCRIPTION OF THE RELATED ART

People that create jobs for print shops, such as graphic designers, may not be aware of best practices when it comes to creating efficient portable document format (PDF) documents that can print with good performance. Thus, print shops will apply PDF optimizations to incoming files. These optimizations attempt to streamline PDFs in order to ensure they may be processed fast enough to drive even the fastest presses. Although these applications can address many PDF inefficiencies, they also introduce complexity and additional processing into the end to end job processing workflow. In addition, because these applications modify jobs, they potentially could introduce rendering errors.

### SUMMARY OF THE INVENTION

A method for optimizing printing operations is disclosed. The method includes determining a page of a print job is complex. The method also includes applying at least one optimization operation to the page. The method also includes generating an optimized page from the page and the at least one optimization operation.

In additional embodiments, the method also includes evaluating whether the optimized page is complex according to a complexity criterion. The method also includes, if the optimized page is still complex, processing the optimized page using a specially configured raster image processor (RIP).

In additional embodiments, the method also includes training a neural network with the page, the at least one optimization operation, and the optimized page. In some embodiments, the at least one optimization operation includes a plurality of optimization operations. In some embodiments, the method also includes removing an optimization operation from the plurality of optimization operations prior to training the neural network. In some embodiments, the method also includes applying the trained neural network to a subsequent page. The method also includes determining at least one preferred optimization operation for the subsequent page using the trained neural network.

In some embodiments, the at least one optimization operation includes at least one of an application of a lower resolution, use of a pre-rendered image, flatness of a vector object or a transparency, and use of an embedded font. In some embodiments, the optimized page has a lower processing overhead than the page.

A method for training a neural network to optimize printing operations is disclosed. The method includes applying at least one optimization operation to a complex page of a print job. The method also includes generating an optimized page from the complex page and the at least one optimization operation. The method also includes training the neural network with the complex page, the at least one optimization operation, and the optimized page. The neural network is trained to apply the at least one optimization operation to a subsequent complex page.

In some embodiments, the at least one optimization operation includes a plurality of optimization operations. In additional embodiments, the method also includes applying a first optimization operation of the plurality of optimization operations to the complex page. The method also includes evaluating whether the optimized page is complex after application of the first optimization operation. In additional embodiments, the method also includes removing the first optimization operation from the plurality of optimization operations to train the neural network if the optimized page is complex. In additional embodiments, the method also includes applying a second optimization operation of the plurality of optimization operations to the complex page after the application of the first optimization operation.

A method for optimizing printing operations at a printing device is disclosed. The method includes determining a page of a print job is complex. The method also includes applying at least one optimization operation to the page. The method also includes generating an optimized page from the page and the at least one optimization operation. The method also includes training a neural network with the page, the at least one optimization operation, and the optimized page. The method also includes applying the trained neural network to a subsequent page to identify the at least one optimization operation for a subsequent page similar to the page. The method also includes optimizing the subsequent page with the at least one optimization operation.

In some embodiments, that at least one optimization operation includes a plurality of optimization operations. In additional embodiments, the method also includes evaluating whether the optimized pages is complex according to a complexity criterion. The method also includes, if the optimized page is still complex, processing the optimized page using a specially configured raster image processor (RIP). In some embodiments, training the neural network includes training the neural network with the processed optimized page and the specially configured RIP.

### BRIEF DESCRIPTION OF THE DRAWINGS

Various other features and attendant advantages of the present invention will be more fully appreciated when considered in conjunction with the accompanying drawings.

FIG. 1 illustrates a printing system for managing jobs according to the disclosed embodiments.

FIG. 2 illustrates a block diagram of components of the printing device for use within the printing system according to the disclosed embodiments.

FIG. 3 illustrates a block diagram of a RIP system for use in processing a job in the printing system according to the disclosed embodiments.

FIG. 4 illustrates a block diagram of an example RIP used within the RIP system according to the disclosed embodiments.

FIG. 5 illustrates a block diagram of a manager of the RIP system configuring a RIP instance according to the disclosed embodiments.

FIG. 6 illustrates a flow diagram for page complexity detection in the RIP system according to the disclosed embodiments.

FIG. 7 illustrates a flow diagram for page complexity determination according to the disclosed embodiments.

FIG. 8 illustrates a block diagram of the components used for page complexity determination according to the disclosed embodiments.

FIG. 9 illustrates a flow diagram for establishing one or more weights of page objects to be used in determining a page weight according to the disclosed embodiments.

FIG. 10 illustrates a block diagram of the complexity rules for use in page complexity determination according to the disclosed embodiments.

FIG. 11 illustrates a block diagram of the application of a PDF optimization operation to a complex page according to the disclosed embodiments.

FIG. 12 illustrates a block diagram of a supervised learning pipeline for a neural network model to select an optimization operation according to the disclosed embodiments.

FIG. 13 illustrates a flowchart for applying an optimization operation to a complex page according to the disclosed embodiments.

FIG. 14 illustrates a flowchart for evaluating and adjusting PDF optimization operations according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

The disclosed embodiments provide a printing system that leverages the functionality of page processing prediction to dynamically optimize selected PDF pages. The system would perform the following operations when jobs are received. Pages are evaluated for complexity using page processing prediction. If a page is deemed to be complex, then the disclosed embodiments may apply optimizations to the specific page. The optimizations may be made available within the printing system. After the page is optimized, the disclosed embodiments may evaluate the page once again to determine whether the page should still be considered complex. If the page still is considered complex, then the disclosed embodiments may additionally process it using a specially configured RIP.

In addition, the disclosed embodiments may instantiate a second machine learning model and train that model in order to determine the effectiveness of the PDF optimization. The model may be trained using the specific PDF optimizations that were applied to the job and using the results of the second complexity evaluation. Additionally, the PDF optimization model may be trained using job processing data.

The disclosed embodiments may adjust the optimizations that are applied to the job using the trained model in order to weed out optimizations that have little, if any, impact on job processing. In order to fine tune this process, the disclosed embodiments may apply one optimization at a time and then perform the complexity evaluation after each optimization. This feature would allow the disclosed embodiments to correlate PDF optimizations to specific PDF characteristics which in turn would allow the system to dynamically select optimizations that should be applied to a given page.

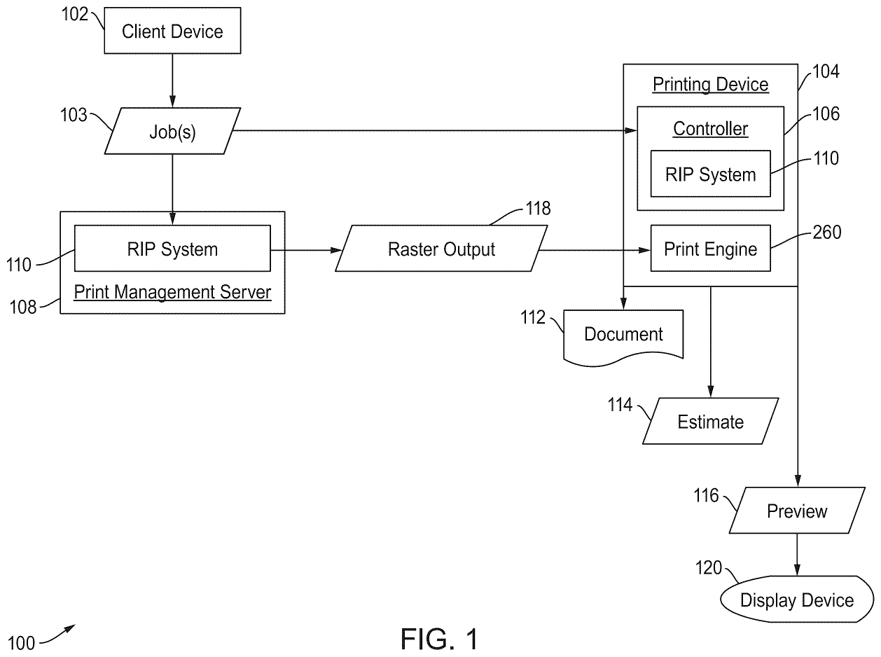

FIG. 1 depicts a printing system 100 for managing jobs using RIP system 110 according to the disclosed embodiments. Printing system 100 may be located in a print shop or other environment suitable for production printing operations. Printing system 100 includes one or more printing devices 104 that receive jobs 103 from one or more client terminals 102.

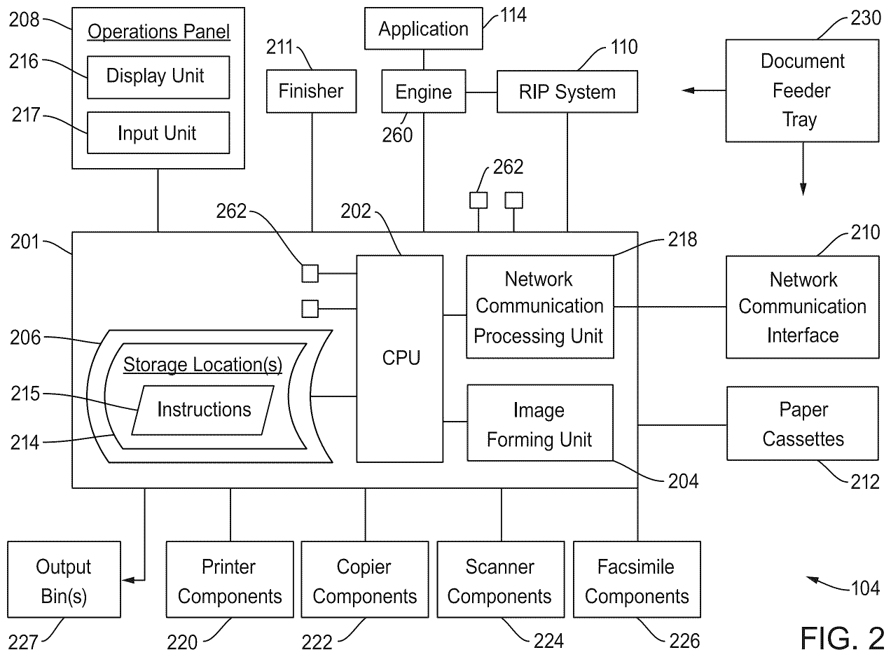

Printing device 104 receives jobs through printing system 100, such as job 103. In some embodiments, job 103 is a print job. After processing job 103, printing device 104 may print or produce document 112 in a paper or media specified by the print job. Printing device 104 is disclosed in greater detail in FIG. 2. Printing device 104 also includes a controller, or digital front end (DFE), 106, which facilitates processing job 103. Controller 106 also includes RIP system 110, which is disclosed in greater detail below.

For example, controller 106 may use RIP system 110 to convert bitmap images, vector graphics, fonts, and the like associated with pages in job 103 to bitmap/rasterized representations of the pages, such as C, M, Y, and K pixels. The sum of the values of pixels of a particular color in the rasterized pages may be proportional to the amount of consumables used by printing device 104 to print that color. RIP system 110 may rasterize pages of job 103 according to various image rasterization settings. For example, these image rasterization parameters may include calibration curves, paper definitions, ICC profiles, spot color definitions, TRCs, color conversion settings, colorant limits for ink or toner, rendering intent, K preservation, CGR level, max colorant densities, print margins, halftones, and the like.

Print engine 260 also is included with printing device 104. Printing device 104 may correspond to an industrial printing device capable of printing thousands of pages in an hour. Printing device 104 may be ink-based, toner-based, or both. Print engine 260 may include various parameters that can control the operation of printing device 104. For example, these settings may include printing device maintenance settings that control or effect head cleaning intervals, head clogging prevention intervals, and the like of printing device 104. Print engine 260 receives raster output from RIP system 110 in printing device 104 to print document 112 based on job 103.

Printing system 100 receives job 103 and may route it directly to printing device 104. Alternatively, printing system 100 may route job 103 to print management server 108. Print management server 108 may seek to offload processing of job 103 from controller 106 of printing device 104. This feature may be desirable if controller 106 does not have the processing capacity to handle jobs 103 in a production printing environment. Thus, print management server 108 also may include RIP system 110 that can provide raster output 118 directly to print engine 260 of printing device 104. These embodiments allow controller 106 to offload processing in order to handle other operations. Further, updates to RIP system 110 may occur at print management server 108 prior to any updates to RIP system 110 in printing device 104.

Job 103 is not always a print job that produces document 112. In some embodiments, job 103 may be an estimation job or a preview job. RIP system 110 determines which type of job is job 103 and configures itself accordingly. For an estimation job, RIP system 110 configures RIPs to process job 103 without impacting print processing within controller 106. The estimation RIPs process job 103 to provide an ink or toner estimate 114. Estimate 114 may be provided to an operator without engaging print engine 260.

For a preview job, RIP system 110 configures RIPs to process job 103 to quickly generate a lower resolution output as preview 116. Preview 116 may be a lower resolution output as compared to document 112 and estimate 114. Preview 116 is provided to the operator to review. Preview 116 may be provided to display device 120 for the operator to review and interact with using an interface. Display device 120 may be a separate device from client device 102 and printing device 104. In other embodiments, display device 120 may be incorporated within client device 102 or printing device 104.

As disclosed above, RIP system 110 may be a smart system that enables optimal processing by using page complexity determination to handle a variety of jobs 103. Different jobs received at printing device 104 or print management server 108 result in different output, such as document 112, estimate 114, or preview 116. The RIP instances within RIP system 110 are configured according to the type of job 103 is received.

FIG. 2 depicts a block diagram of components of printing device 104 according to the disclosed embodiments. The architecture shown in FIG. 2 may apply to any multi-functional printing device or image forming apparatus that performs various functions, such as printing, scanning, storing, copying, and the like within printing system 100. As disclosed above, printing device 104 may send and receive data from client device 102, print management server 108, if a separate device, and other devices within system 100.

Printing device 104 includes a computing platform 201 that performs operations to support these functions. Computing platform 201 includes a computer processing unit (CPU) 202, an image forming unit 204, a memory unit 206, and a network communication interface 210. Other components may be included but are not shown for brevity. Printing device 104, using computing platform 201, may be configured to perform various operations, such as scanning, copying, printing, receiving or sending a facsimile, or document processing. As such, printing device 104 may be a printing device or a multi-function peripheral including a scanner, and one or more functions of a copier, a facsimile device, and a printer. To provide these functions, printing device 104 includes printer components 220 to perform printing operations, copier components 222 to perform copying operations, scanner components 224 to perform scanning operations, and facsimile components 226 to receive and send facsimile documents. CPU 202 may issue instructions to these components to perform the desired operations.

Printing device 104 also includes a finisher 211 and one or more paper cassettes 212. Finisher 211 includes rotatable downstream rollers to move papers with an image formed surface after the desired operation to a tray. Finisher 211 also may perform additional actions, such as sorting the finished papers, binding sheets of papers with staples, doubling, creasing, punching holes, folding, and the like.

Paper cassettes 212 supply paper to various components 220, 222, 224, and 226 to create the image formed surfaces on the papers. Paper cassettes 212 also may be known as paper trays. Paper cassettes 212 may include papers having various sizes, colors, composition, and the like. Papers or media within paper cassettes 212 may be considered “loaded” onto printing device 104. The information for printing these papers may be captured in a paper catalog stored at controller 106. Paper cassettes 212 may be removed to refill as needed. The printed papers from components 220, 222, 224, and 226 are placed within one or more output bins 227. One or more output bins 227 may have an associated capacity to receive finished print jobs before it must be emptied or printing paused. The output bins may include one or more output trays.

Document processor input feeder tray 230 may include the physical components of printing device 104 to receive papers and documents to be processed. Feeder tray also may refer to one or more input trays for printing device 104. A document is placed on or in document processor input feeder tray 230, which moves the document to other components within printing device 104. The movement of the document from document processor input feeder tray 230 may be controlled by the instructions input by the user. For example, the document may move to a scanner flatbed for scanning operations. Thus, document processor input feeder tray 230 provides the document to scanner components 224. As shown in FIG. 2, document processor input feeder tray 230 may interact with print engine 260 to perform the desired operations.

Memory unit 206 includes memory storage locations 214 to store instructions 215. Instructions 215 are executable on CPU 202 or other processors associated with printing device 104, such as any processors within components 220, 222, 224, or 226. Memory unit 206 also may store information for various programs and applications, as well as data specific to printing device 104. For example, a storage location 214 may include data for running an operating system executed by computing platform 201 to support the components within printing device 104. According to the disclosed embodiments, memory unit 206 may store the tokens and codes used in performing the deferral operations for printing device 104.

Memory unit 206 may comprise volatile and non-volatile memory. Volatile memory may include random access memory (RAM). Examples of non-volatile memory may include read-only memory (ROM), flash memory, electrically erasable programmable read-only memory (EEPROM), digital tape, a hard disk drive (HDD), or a solid-state drive (SSD). Memory unit 206 also includes any combination of readable or writable volatile memories or non-volatile memories, along with other possible memory devices.

Computing platform 201 may host one or more processors, such as CPU 202. These processors are capable of executing instructions 215 stored at one or more storage locations 214. By executing these instructions, the processors cause printing device 104 to perform various operations. The processors also may incorporate processing units for specific purposes, such as application-specific integrated circuits (ASICs) and field programmable gate arrays (FPGAs). Other processors may be included for executing operations particular to components 220, 222, 224, and 226. In other words, the particular processors may cause printing device 104 to act as a printer, copier, scanner, and a facsimile device.

Printing device 104 also includes an operations panel 208, which may be connected to computing platform 201. Operations panel 208 may include a display unit 216 and an input unit 217 for facilitating interaction with a user to provide commands to printing device 104. Display unit 216 may be any electronic video display, such as a liquid crystal display (LCD). Input unit 217 may include any combination of devices that allow users to input information into operations panel 208, such as buttons, a touch screen, a keyboard or keypad, switches, dials, and the like. Preferably, input unit 217 includes a touch-screen digitizer overlaid onto display unit 216 that senses touch to receive inputs from the user. By this manner, the user interacts with display unit 216. Using these components, one may enter codes or other information into printing device 104.

Display unit 216 also may serve as to display results from print management server 108. Display unit 216 may act as display device 120 for displaying preview 116 after it is generated by RIP system 110.

Printing device 104 also includes network communication processing unit 218. Network communication processing unit 218 may establish a network communication using network communication interface 210, such as a wireless or wired connection with one or more other image forming apparatuses or a network service. CPU 202 may instruct network communication processing unit 218 to transmit or retrieve information over a network using network communication interface 210. As data is received at computing platform 201 over a network, network communication processing unit 218 decodes the incoming packets and delivers them to CPU 202. CPU 202 may act accordingly by causing operations to occur on printing device 104. CPU 202 also may retrieve information stored in memory unit 206, such as settings for printing device 104.

Printing device 104 also includes print engine 260, as disclosed above. Engine 260 may be a combination of hardware, firmware, or software components that act accordingly to accomplish a task. For example, engine 260 is comprised of the components and software to print a document. It may receive instructions from computing platform 201 after user input via operations panel 208. Alternatively, engine 260 may receive instructions from other attached or linked devices.

Engine 260 manages and operates the low-level mechanism of the printing device engine, such as hardware components that actuate placement of ink or toner onto paper. Engine 260 may manage and coordinate the half-toner, toner cartridges, rollers, schedulers, storage, input/output operations, and the like. RIP system 100 that interprets the page description languages (PDLs) would transmit and send instructions down to the lower-level engine 260 for actual rendering of an image and application of the ink onto paper during operations on printing device 104. RIP system 110 may be located in DFE 106, as disclosed above. Alternatively, RIP system 110 may be located on print management server 108 and directly communicates with print engine 260.

Printing device 104 may include one or more sensors 262 that collect data and information to provide to computing platform 201 or CPU 202. Each sensor 262 may be used to monitor certain operating conditions of printing device 104. Sensors 262 may be used to indicate a location of a paper jam, failure of hardware or software components, broken parts, operating system problems, document miss-feed, toner level, as well as other operating conditions. Sensors 262 also may detect the number of pages printed or processed by printing device 104. When a sensor 262 detects an operational issue or failure event, it may send a signal to CPU 202. CPU 202 may generate an error alert associated with the problem. The error alert may include an error code.

Some errors have hardware-related causes. For example, if a failure occurred in finisher 211, such as a paper jam, display unit 216 may display information about the error and the location of the failure event, or the finisher. In the instance when the paper jam occurs in paper cassettes 212, display unit 216 displays the information about the jam error as located in one of the paper cassettes.

Some errors have a type of firmware-related cause. For example, network communication processing unit 218 may cause a firmware or software error. Display unit 216 may display the firmware-related error, any applicable error codes, and provide recommendations to address the error, such as reboot the device.

Memory unit 206 may store the history of failure events and occurred errors with a timestamp of each error. Printing device 104 communicates with other devices within system 100 via network communication interface 210 by utilizing a network protocol, such as the ones listed above. In some embodiments, printing device 104 communicates with other devices within system 100 through REST API, which allows the server to collect data from multiple devices within system 100. REST API and SOAP are application protocols used to submit data in different formats, such as files, XML messages, JSON messages, and the like. By utilizing applicable network communication protocols and application protocols, printing device 104 submits and receives data from client device 102 and print management server 108 as well as other printing devices within printing system 100.

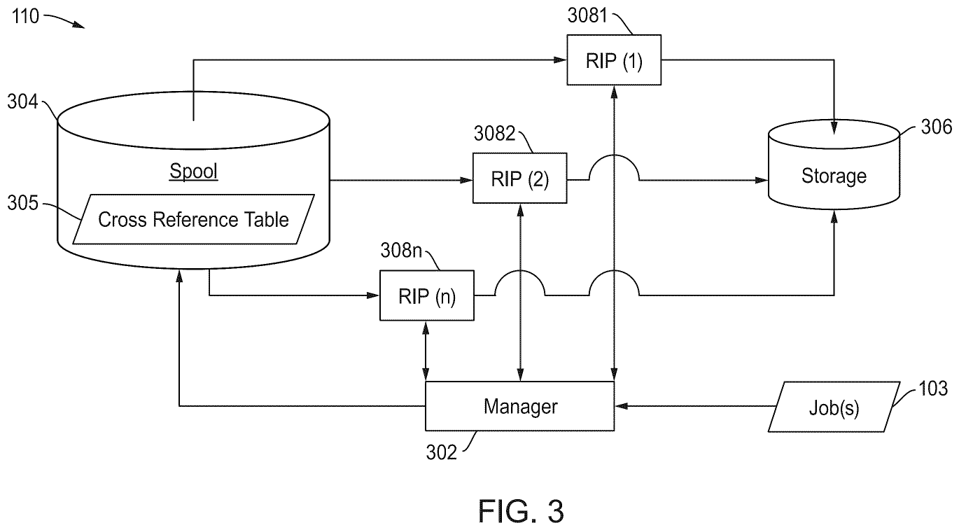

FIG. 3 depicts a block diagram of RIP system 110 for use in processing job 103 in printing system 100 according to the disclosed embodiments. As disclosed above, RIP system 110 may be located in controller 106 of printing device 104. It also may be located on print management server 108 such that it communicates directly with print engine 260 of printing device 104.

RIP system 100 includes RIP manager 302 and RIP instances RIP 3081, RIP 3082, and RIP 308n. A RIP instance may be a RIP configured by manager 302 to process job 103. A RIP instance may be a standard RIP, a high performance RIP, a very high performance RIP, a preview RIP, an estimation RIP, or a failover RIP. All RIP instances and manager 302 operate in parallel to each other.

Manager 302 performs a variety of operations. It may contain multiple subunits that operate in parallel to perform the variety of operations, like spooling job 103, managing job 103, managing pages or segments of job 103, managing RIP instances 3081, 3082, and 308n, managing drives, determining the PDL type of job 103, distributing pages of segments of job 103 to the RIP instances, serializing pages or segments of job 103, sending notifications within printing device 104 or print management server 108.

Manager 302 may receive job 103 through printing system 100. Job 103 may be received from client device 102 via internet protocols within printing system 100. Job 103 may be spooled by manager 302 and stored in spool drive 304. Spool drive 304 may be a configurable drive. Manager 302 determines the PDL type of job 103. It then creates a cross reference table 305 in spool drive 304, which acts as a shared memory with RIP instances 3081, 3082, and 308n. Manager 302 also may create print ticket information in spool drive 304.

Manager 302 analyzes job 103 to determine which type of job it is. It uses this information to determine the number of RIPs and type of RIPs to be used in processing job 103. These features are disclosed in greater detail below. Depending on the type of job, manager 302 configures RIP instances 3081, 3082, and 308n. A configuration operation may create a RIP having a certain number of renderers. For example, RIP instance 3081 may be a standard RIP having a normal number of renderers, such as 4. RIP instance 3082 may be a high performance RIP that has a higher number of renders, such as 6. Manager 302 configures the RIP instances accordingly to process job 103.

Manager 302 then distributes pages or segments of job 103 to RIP instances 3081, 3082, and 308n. Job 103 may be a print job that is split into segments or pages for parallel processing. As RIP instance 3082 is a high performance RIP, then it may receive specific pages or segments of job 103. Pages may refer to one or more pages of job 103. Segments of job 103 also may refer to a number of pages or a block of data within job 103. The pages or segments are distributed by manager 302 using inter-process communication.

RIP instances 3081, 3082, and 308n may read cross reference table 305 along with print ticket information and the spooled data for job 103. Each RIP instance then processes the page or segment that it is instructed to by manager 302. The RIP instance may check cross reference table 305 to obtain any instructions in the print ticket information and the data for the page or segment in spool drive 304. RIP instances 3081, 3082, and 308n then parse the data for the page or segment to create metadata from the drawing commands.

The RIP instances render the metadata to storage 306. Storage 306 may store the rendered pages for a print job of job 103. The rendered pages may be stored according to a specific image format, such as the KYOCERA™ Image Format (KIF). The stored pages may then be provided to print engine 260 to print document 112. For jobs 103 that do not require rendered pages, such as previews and estimates, the data generated by the RIP instances may be provided back to manager 302 for further operations.

RIP system 110 provides advantages over conventional RIP systems. Manager 302 may control the number of renderers per RIP. It may increase the number to process a page or segment faster. It also may increase the amount of memory allocated to the RIP as faster processing consumes more memory. If processing is to be slower, such as for estimate 114 or preview 116, then the configured RIP should consume less memory. Manager 302 manages these requirements through dynamic configuration of the RIPs based on the parameter of job 103.

In some instances, manager 302 may determine that job 103 is not able to be split into pages or segments for parallel processing. Thus, it may configure a RIP instance, such as RIP instance 308n, into a very high performance RIP. The very high performance RIP uses more renderers than the high performance RIP. For example, RIP instances 308n may be configured to use 8 renderers. This feature increases the processing speed of RIP instance 308n. Manager 302 may still use RIP instances 3081 and 3082 for parallel processing on one job 103 while using RIP instance 308n for processing another job 103 that is not able to be broken into pages or segments.

RIP system 110 provides features available due to the parallel processing using dynamically configured RIP instances. RIP system 110 may configure a high performance RIP to improve the first page out time. It also may use differently configured RIPs for different purposes, such a preview RIPs, estimation RIPs, and failover RIPs. RIP system 110 also may configure very high performance RIPs for jobs that cannot be processed in a page or segment parallel manner.

RIP system 110 also provides the ability to change the number of renderers per RIP. RIP system 110 also changes the number of RIP instances based on its workload, which includes shutting down certain types of RIPs in order to launch other types of RIPs. RIP system 100 also processes different kinds of jobs in RIPs with different configurations. RIP system 110 also uses different RIPs with different configurations for different purposes. It configures RIP instances with different imaging pipelines. RIP system 110 also retries failed jobs or job pages in a differently configured RIP instance.

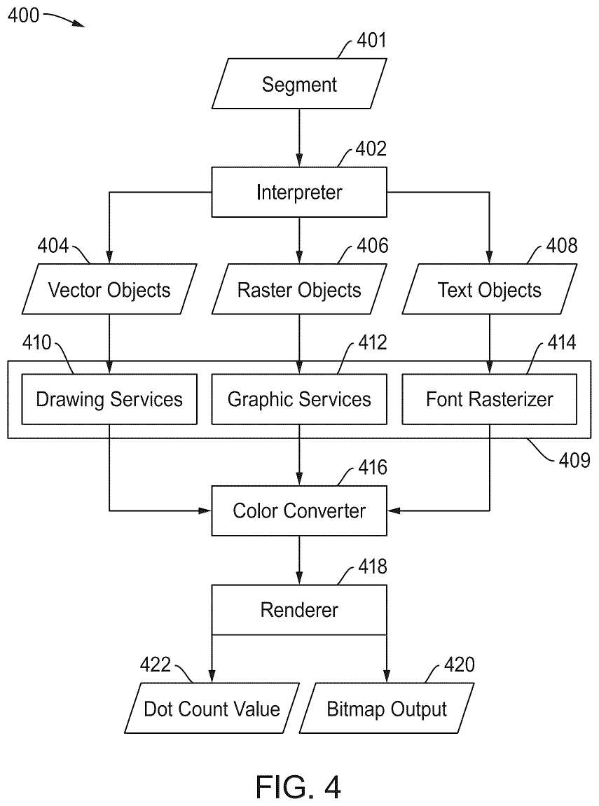

FIG. 4 depicts a block diagram of an example RIP 400 used within RIP system 110 according to the disclosed embodiments. RIP 400 may represent a configuration for RIP instances 3081, 3082, or 308n. RIP 400 may represent the hardware and software configurations used to determine what value each pixel or spot of output should possess, driven by commands from a page description language (PDL). Computer-generated output may be composed of very small spots. RIP 400 converts a vector-based image, or a stored image, into a series of mathematical formulas that describe lines and curves into a pattern of spots needed to generate the output, or raster image. Interpreter 402 converts a job file into a display list, which is then converted into a bitmap output 418 describing a page of the document.

RIP 400 converts text and image data from different file formats including PDF, TIFF, or JPEG into a format that printing device 104 can understand. The process of raster image processing a page implements several steps to be performed, regardless whether the page is submitted as PostScript, PDF, or any other page description language (PDL). In short, RIP 400 may provide interpretation, rasterization, and screening.

Segment 401 may be a job file associated with job 103. Segment 401 may be provided to RIP 400 to convert its code into raster or bitmap code. As disclosed above, manager 302 receives job 103. Manager 302 may split job 103 into segments for parallel processing by the RIP instances. Preferably, segment 401 is a page the document in job 103. RIPs process pages in a parallel manner within RIP system 100. RIP 400 is one of the RIP instances. In other embodiments, segment 401 may be several pages, a graphic design, or other portion of job 103.

Segment 401 is received at interpreter 402, which interprets the commands in the code to redraw the object and elements of a page as vector objects 404, raster objects 406, and text objects 408. Interpreter 402 parses specific PDLs into drawing commands. The PDL of segment 401 is read and decoded into graphical elements to be placed on a sheet. Each element may be an image, a character of text, a fill, stroke, and the like or listed in vector objects 404, raster objects 406, and text objects 408.

Drawing unit 409 receives vector objects 404, raster objects 406, and text objects 408 to convert the drawing commands into metadata that can be provided to renderer 418. Thus, drawing unit 409 converts vector objects 404 into drawing services 410. It also converts raster objects 406 into graphic services 412. It also converts text objects into font rasterizer 414.

RIP 400 also may implement color converter 416. Color converter 416 may implement color conversion operations for the metadata generated by drawing unit 409. Color converter 416 provides color management and calibration. These actions may be applied during interpretation or rendering, depending on configuration and job content. Color printing resources may be accessed to provide the color management.

Renderer 418 processes the metadata from drawing unit 409 to convert every graphical element into the appropriate pattern of pixels to form the output raster. The resolution independent vector objects 404 as drawing services 410 are converted into pixels. Screening takes the raster image of pixels to form individually screened cyan, magenta, yellow, and black separations. These are halftone dots in the form of a bitmap output 420 consisting of commands that can be understood by print engine 260.

The disclosed embodiments also may determine dot count value 422 from the rendered image provided by renderer 418. Dot count values may be adjusted based on screening and based on settings at printing device 104. Dot count value 422 may be reported to determine estimate 114 for an estimation job, as disclosed below.

The rendered bitmap output 420 may be stored in storage 306 to be sent to print engine 260 when all the pages or segments of job 103 are processed. RIP 400 shows one path for rendering and providing output. Preferably, RIP 400 multiple rendering paths that use multiple renderers. The disclosed embodiments may use a renderer 418 for each channel in RIP 400, such as one each for cyan, magenta, yellow, and black. The number of renderers 418 may be configured by manager 302 depending on job 103. Each renderer 418 requires memory and processing resources. A high number of renderers 418 in RIP 400 will consume more memory but run faster. A lower number of renderers 418 in RIP 400 will consume less memory but run slower.

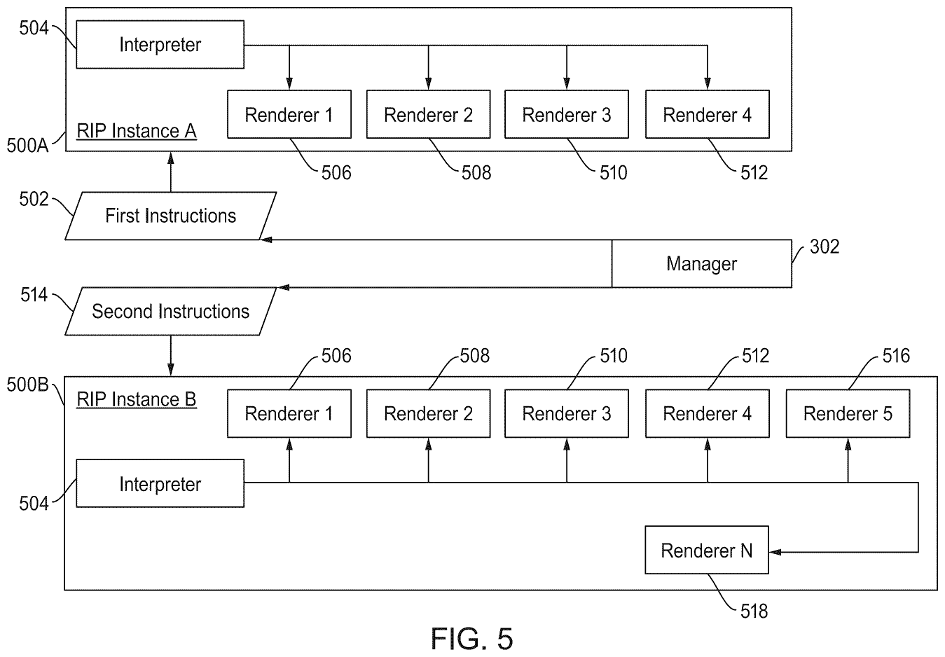

FIG. 5 depicts a block diagram of manager 302 of RIP system 110 configuring a RIP instance 500A according to the disclosed embodiments. Manager 302 may send instructions to RIP instances to change their configuration in response to a need for different RIPs within RIP system 110. These changes may include increasing the number of renderers within the RIP, decreasing the number of renderers within the RIP, changing the type for RIP, and the like. This feature enables RIP system 100 to be configurable to meet the processing requirements for different jobs.

Manager 302 may send first instruction 502 to RIP instance 500A. RIP instance 500 may correspond to RIP 400, as disclosed above. The features of RIP 400 are not repeated here for brevity. RIP instance 500A may be considered a standard RIP that includes interpreter 504 along with renderer 1 506, renderer 2 508, renderer 3 510, and renderer 4 512. Renderers 506-512 may operate to perform functions in processing a print job, providing a preview, or providing an estimate.

First instruction 502 may instruct RIP instance 500A to modify its configuration to meet a current need within RIP system 110. For example, manager 302 may determine that RIP instance 500A needs to reconfigure itself to be a high performance RIP. First instruction 502 includes instructions to increase the number of renderers within RIP instance 500A to become a high performance RIP. The disclosed embodiments execute an operation to reconfigure RIP instance 500A into RIP instance 500B.

After operation 520 is completed, RIP instance 500B includes interpreter 504 along with an increased number of renderers. The increased number of renderers provide RIP instance 500B with increased processing capability but also takes up more memory and resources to accommodate the increased number of renderers. Thus, RIP instance 500B includes renderer 1 506, renderer 2 508, renderer 3 510, renderer 4 512, renderer 5 516, and renderer N 518. Renderer N 518 may be the last renderer implemented in RIP instance 500B. In some embodiments, renderer N 518 may be the sixth renderer. In other embodiments, renderer N 518 may be the eighth renderer such that renderers 6 and 7 also are included in RIP instance 500B, but not shown. RIP instance 500B now includes two or more additional renderers to perform processing of a print job, page, segment, and the like.

Manager 302 may receive another job 103 that requires RIP instance 500B to be reconfigured back to a standard RIP. Second instruction 514 is received at RIP instance 500B. Another operation is executed as a result to reconfigure RIP instance 500B back to four renderers. Processing capability may be reduced, but less memory and resources will be needed. Thus, manager 302 may dynamically configure the RIP instances to become different RIPs, as needed based on job requirements, as well as other factors such as page complexity and available resources.

First instruction 502 also may instruct RIP instance 500A to configure into a preview RIP. This configuration would use the same resources of a standard RIP, so the number of renderers would remain the same. For example, if RIP instance 500A includes 4 renderers then the preview RIP would include 4 renderers. If RIP instance 500A includes 6 renderers then the preview RIP also would include 6 renderers. RIP instance 500A, however, would be configured to generate a lower resolution output.

First instruction 502 also may instruct RIP instance 500A to configure into an estimation RIP. This configuration may reduce the number of renderers, even for a standard RIP. Estimation RIPs use reduced memory allocation. Thus, if RIP instance 500A includes 6 renderers, then it may be reconfigured to have 4 renderers. In some embodiments, the number of renderers may be reduced from 4 to 2.

The disclosed embodiments may configure RIP instance 500A to include any number of renderers. The number of renderers depends on the processing capability needed for job 103, page complexity, and available memory resources. The more renderers, however, then the more memory and resources need to be allocated for the RIP instance. Thus, RIP system 110 may not want a large number of high performance or very high performance RIPs running all the time. Manager 302 dynamically configures RIP system 110 to meet the processing requirements for the received job, whether it is a print job, estimation job, or preview job.

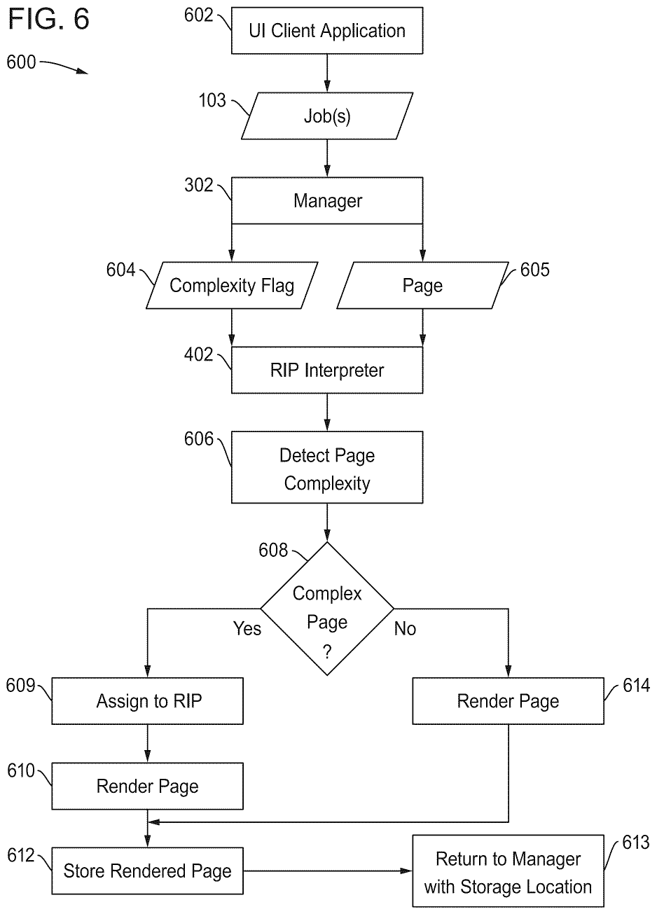

FIG. 6 depicts a flow diagram 600 for page complexity detection in RIP system 110 according to the disclosed embodiments. Flow diagram 600 may refer to FIGS. 1-5 for illustrative purposes. Flow diagram 600, however, may not be limited to the embodiments disclosed by FIGS. 1-5.

In some embodiments, client device 102 may include a user interface or client application 602 to generate job 103 for printing. In other embodiments, a user interface client application 602 may be located at printing device 104 for production printing operations. In any event, such an application 602 generates incoming job 103 to RIP system 110. Complexity detection according to the disclosed embodiments may be implemented in RIP system 110. In some embodiments, complexity detection may be implemented within controller 106 or user interface client application 602.

Within RIP system 110, job 103 is received by manager 302. If job 103 is to undergo a page complexity determination process, then manager 302 may set a complexity page detection flag 604 during the page start request to the RIPs within RIP system 110. Interpreter 402 for a RIP, such as RIP 3081, RIP 3082, or RIP 308n disclosed above, may receive a page 605 from job 103. Interpreter 402 does a preflight inspection of page 605 and collects statistics, only of complexity flag 604 is true.

Step 606 is executed by detecting page complexity for page 605 by interpreter 402. Interpreter 402 determines the page complexity for page 605 based on a weighted formula and a set of rules. These features are disclosed in greater detail below. Using the information gathered and determined, the disclosed embodiments whether page 605 is complex.

Step 608 executes by determining whether page 605 is complex. This process is disclosed in greater detail below. If step 608 is yes, then page 605 is a complex page. RIP system 110 will treat page 605 differently than a simple, or standard page. A complexity level may be determined for page 605 based on criteria, as disclosed below. Depending on the complexity level for page 605, step 609 executes by having manager 302 assign the page to a RIP having the resources, such as renderers, able to process the page at engine speed. If a RIP does not exist to handle the complexity level, then manager 302 may reconfigure a RIP to provide additional processing resources. In some embodiments, the assigned RIP may be a high performance RIP or a very high performance RIP.

Step 610 executes by rendering page 605 within the assigned RIP. Step 612 executes by storing rendered page 605 in storage 306 by the assigned RIP, as disclosed above. Specifically, rendered page 605 is added to rendered pages 516 in storage 306 with a location within the storage to retrieve the rendered page. Step 613 executes by returning to manager 302 with the storage location of rendered page 605 in storage 306.

If step 608 is no, then page 605 is a simple, or non-complex, page. Step 614 executes by rendering page 605 using a standard RIP. A complexity level is not determined for page 605 and a RIP is not reconfigured. Flow diagram 600 then proceeds to step 612, as disclosed above.

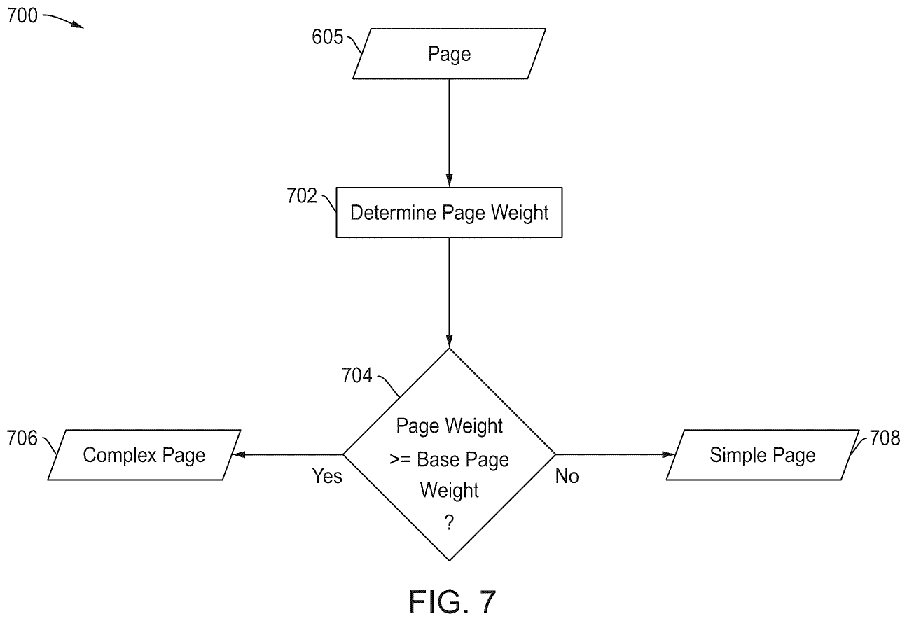

FIG. 7 depicts flow diagram 700 for page complexity determination according to the disclosed embodiments. Flow diagram 700 may refer to FIGS. 1-6 for illustrative purposes. Flow diagram 700, however, is not limited by the embodiments disclosed by FIGS. 1-6. Flow diagram 700 may be implemented in RIP system 110. More specifically, it may be implemented in an interpreter 402 of a RIP within RIP system 110. In other embodiments, flow diagram 700 may be implemented elsewhere within printing system 100, such as controller 106 or client application 602.

Page 605 is received at RIP 400 having interpreter 402. Page 605 may be part of job 103, which has its complexity flag 604 set to enable page complexity determination operations. Step 702 executes by determining a page weight for page 605. This process is disclosed in greater detail below and is based on a set of rules and a weighted formula. Step 704 executes by determining whether the page weight is greater than or equal to a base page weight. The base page weight is disclosed in greater detail below and is determined based on the engine speed of print engine 260. Thus, determining whether a page is complex relates to whether the page can be rendered “at speed” during printing operations.

If step 704 is yes, then page 605 is marked as a complex page in step 706. Referring to flow diagram 600, page 605 is rendered by the RIP. If step 704 is no, then page 605 is marked as a simple page in step 708. Page 605 is rendered as shown by flow diagram 600.

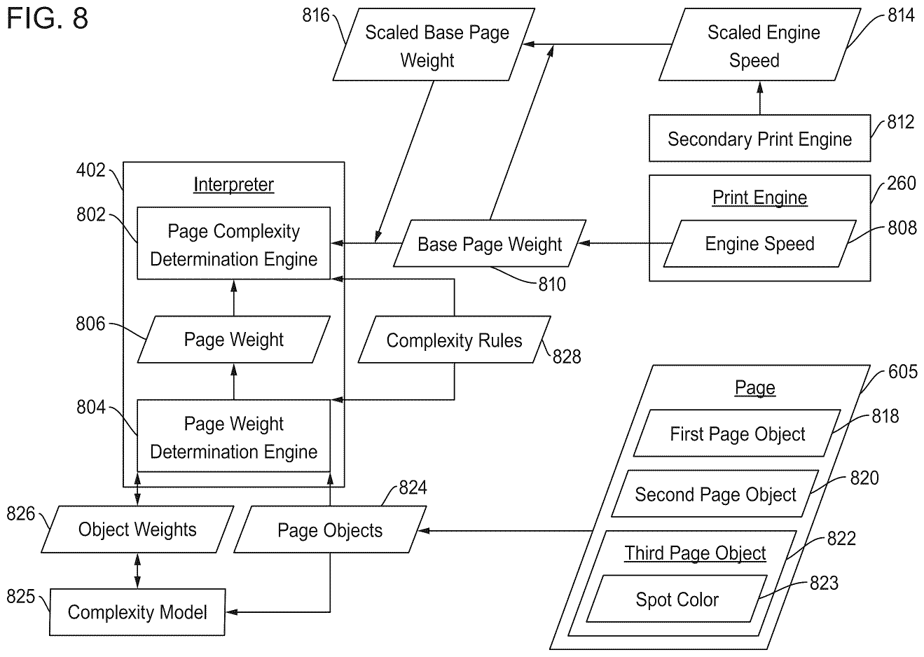

FIG. 8 depicts a block diagram of the components used for page complexity determination according to the disclosed embodiments. As disclosed above, base page weight 810 and page weight 806 are determined to be used in deciding whether page 605 is complex or simple. Both of these values are calculated using information available from printing device 104, objects without page 605, and complexity rules 828. These features are disclosed in greater detail below.

Base page weight 810 relates to engine speed 808 of print engine 260 of printing device 104. Engine speed 808 may refer to the pages or sheet per minute that printing engine 260 can process, or put ink to paper. This speed may refer to an average speed for a number of previous print jobs, or to the speed to print a page having no objects, such as one with only text. The disclosed embodiments may assign a weight, or value, to engine speed 808.

For example, print engine 260 may have an engine speed 808 of 150 PPM. This value may be based off previous print jobs and their engine speed to print pages of those jobs, regardless of the content on those pages. Alternatively, the disclosed embodiments may take the engine speed of printing certain types of pages, such as text only, pages with objects, pages with color printing, and the like. Using this example, base page weight 810 for engine speed 808 of 150 PPM may be 10.0. Base page weight 810 also may be used to distribute a weightage to different operators on a page, as disclosed below.

In some embodiments, a scaled base page weight 816 may be used that is based on base page weight 810 for another print engine at a separate printing device within printing system 100. For example, secondary print engine 812 may be located in another printing device separate from printing device 104. Once base page weight 810 is established for print engine 260, it may be scaled for different engine speeds as it may be presumed that rendering performance increases or decreases with engine speed.

Thus, scaled engine speed 814 may be the engine speed for secondary print engine 812. Again, scaled engine speed 814 may be determined based on previous print jobs or other criteria. Scaled engine speed 814 will cause base page weight 810 to be scaled to determine scaled base page weight 816 for secondary print engine 812. If scaled engine speed 814 differs from engine speed 808, then scaled base page weight 816 differs from base page weight 810 in a corresponding fashion.

For example, for base page weight 810 of 10.0 for engine speed 808 of 150 PPM, a scaled engine speed 814 of 300 PPM would have a scaled base page weight 816 of 20.0. Secondary print engine 812 can process pages having a higher page weight as it is faster than print engine 260. It would take more objects on a page to have it considered “complex.” More complex pages will not delay secondary print engine 812 as it may do for print engine 260. According to these embodiments, base page weight 810 may be used to determine scaled base page weights for any number of print engines within printing system 100.

For determining page weight 806, a page weight determination engine 804 may be implemented within interpreter 402 of a RIP within RIP system 110. Page weight determination engine 804 also may be implemented elsewhere in controller 106, print management server 108, or client application 602. Page weight determination engine 804 may take into account page objects 824 from page 605, object weights 826, and complexity rules 828. These features are disclosed separately below.

Page objects 824 are objects, such as images, graphics, text, and the like, within page 605. For example, page 605 may include first page object 818, second page object 820, and third page object 822. Third page object 822 may include a spot color 823 that is required to print the third page object accurately. As disclosed above, an object may have a type, such as vector, text, or image. Objects may be further classified into operators, such as form, shading, group, Type 3 characters, pattern, font, color space, spot color, and the like. For example, first page object 818 may be a vector object having shading as an operator, second page object 820 may be a text object having a specific font and several Type 3 characters as operators, and third page object 822 may be an image object having spot color 823 as an operator.

The disclosed embodiments may compile the page objects and their operators into page objects 824 for page 605. Page objects 824 are provided to page weight determination engine 804. Page weight determination engine 804 may use one or more weighted formulas plus complexity rules 828 to determine the weights for page objects 824. The weighted formulas also may rely on object weights 826 provide from complexity model 825. The disclosed embodiments gather statistics and generates complexity model 825 based on these determinations. Complexity model 825 is based on various components of a page, such as the type of objects disclosed above, or vector, text, or image. The objects in complexity model 825 also may be further classified into operators.

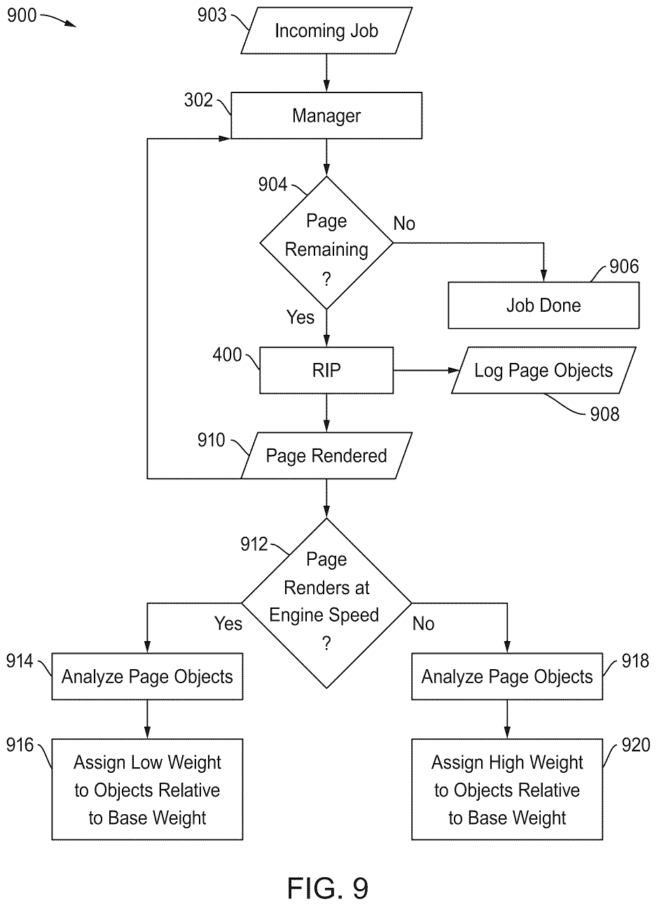

The generation of complexity model 825 and determining object weights for use by page weight determination engine 804 may be disclosed by FIG. 9. FIG. 9 depicts a flow diagram 900 for establishing one or more weights of page objects to be used in determining page weight 806 according to the disclosed embodiments. Flow diagram 900 may refer to FIGS. 1-8 for illustrative purposes. Flow diagram 900, however, is not limited to the embodiments disclosed by FIGS. 1-8.

The process disclosed by flow diagram 900 assigns weight to different objects in a page. The objects may include operators, such as shading, color space, pattern, path, image, form, text, fonts, group, color, and the like. The objects also may include data, such as form size, path size, image size, shade size, and the like. These objects are weighted relative to base page weight 810 for print engine 260.

The weights for the objects are assigned after analyzing each object over a large selection of jobs that are rendered by a RIP 400 of RIP system 110. RIP 400 is disclosed above. A weighted formula uses the operators, operator count, and the size of the operators to determine page weight 806. For example, printing device 104 may process a large number of print jobs. RIP system 110 or controller 106 may execute flow diagram 900 to determine object weights to be included in complexity model 825.

Flow diagram 900 starts with incoming job 903 being received within RIP system 110. Manager 302 may receive incoming job 903 having a plurality of pages. Incoming job 903 may be different than job 103 disclosed above as it is not being analyzed to determine its page weight but to provide data to establish complexity model 825 for determine page weights. For each page of incoming job 903, step 904 is executed by determining whether any pages are remaining from incoming job 903 to render. If no, then step 906 executes by indicating that job 903 is done. No more pages are to be rendered.

If step 904 is yes, then the page is provided to RIP 400 for processing and rendering, as disclosed above by FIG. 4. RIP 400 includes interpreter 402. Step 908 executes by logging page objects identified by RIP 400 within the rendered page. In some embodiments, the page from incoming job 903 may only have one page object, such as text, but with different operators, such as multiple fonts or unique characters. Step 910 executes by rendering the page and indicating this fact to manager 302.

After the page is rendered, step 912 executes by determining whether the page from incoming print job 903 is rendered at engine speed 808 for print engine 260. If yes, then step 914 executes by analyzing page objects logged in step 908. Again, these page objects may have specific operators, or data. Step 916 executes by assigning a low weight to the page objects relative to base page weight 810. As these page objects did not hinder processing of the page, they should not cause pages that use the objects in the future to slow down rendering of the pages.

If step 912 is no, then the page is not rendered at engine speed 808. Step 918 executes by analyzing page objects logged in step 908. Again, these page objects may have specific operators, or data. Step 920 executes by assigning a high weight to the page objects relative to base page weight 810. As these page objects did hinder processing of the page, these page objects will cause delays in processing and rendering in subsequent print jobs.

For example, a first page of incoming job 903 may be rendered by RIP 400 at engine speed 808. The first page includes two page objects having unique operators. The disclosed embodiments may assign a low weight to each of the page objects and their operators. If base page weight 810 is a certain amount, then each page object and the operators may receive a weight that is lower than the certain amount. All the object weights, when added together, may correspond to the base page weight. When these same page objects using unique operators are processed in a subsequent print job, they may receive a higher or lower weight, which is captured in complexity model 825. Complexity model 825 adjusts values for the weights over time.

It should be noted that page object weight does not change on subsequent runs, or if contained in a different print job. The weights of the objects will change on the operator used for drawing the object. For example, if the object is drawn with a process color in one job as compared to a spot color in a subsequent, then the weight for the object may change. The base page weight changes depending in the engine speed. A page weight of 9.0 is determined as a simple page with a print engine having the base page weight of 10.0. The same page weight of 9 is determined as complex with an engine having a base page weight of 5.0.

A second page of incoming job 903 also may be rendered by RIP 400, but not at engine speed 808. Second page also may include two page objects having unique operators. The processing and rendering of the second page may take longer than normal. If the processing time took 20% longer than engine speed 808, then a page weight of 12.0 may be assigned to the second page. Thus, weights of 6.0 may be assigned to each page object and its operator. Again, these weights are adjusted as additional pages are processed having similar page objects using different operators.

Using the embodiments disclosed by flow diagram 900, complexity model 825 is built. Referring back to FIG. 8, when page weight determination engine 804 receives page objects 824 of page 605, it may retrieve object weights from complexity model 825. Alternatively, page objects 824 may be provided to complexity model 825, which then provides page object 824 along with object weights 826 to page weight determination engine 804. First page object 818 may be compared to a similar page object in complexity model 825 to obtain a weight for the first page object. Second page object 820 may compared to a similar page object in complexity model 825 to obtain a weight for the second page object. Third page object 822 may be compared to a similar page object in complexity model 825 to obtain a weight for the third page object.

In some embodiments, the object weights for first page object 818, second page object 820, and third page object 822 may be added together to determine page weight 806. The disclosed embodiments, however, also apply complexity rules 828 to further modify weights based on additional factors. Complexity rules 828 may be provided to page weight determination engine 804. Alternatively, complexity rules 828 may be provided to complexity model 825 to apply to specific object weights for page objects that are then provided to page weight determination engine 804.

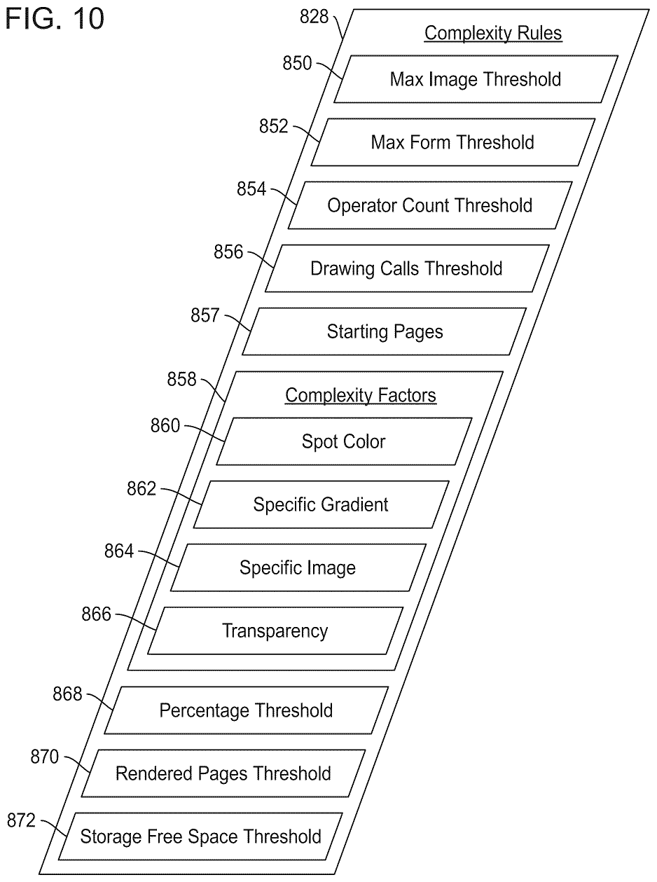

FIG. 10 depicts a block diagram of complexity rules 828 for use in page complexity determination for page 605 according to the disclosed embodiments. Complexity rules 828 may be set by an operator or administrator. Alternatively, complexity factors may be determined using the process disclosed in flow diagram 900 for specific object conditions. If certain features of an object cause marked increase in processing time, then these may be made into a complexity rule.

For example, a page may be marked complex if the complexity formula weight, or page weight 806, exceeds base page weight 810. This rule may be applicable for all page complexity determination processes and disclosed above. In some complexity rules 828, this may be the only rule. Another rule may be that a page is marked complex if the size of a single image exceeds a maximum image threshold 850. Maximum image threshold 850 may include a value that causes the page to automatically be marked complex if an image on the page is above the threshold.

Another rule may be that a page is marked complex if the size of a single form exceeds a maximum form threshold 852. Maximum form threshold 852 also may include a value that causes the page to automatically be marked complex if a form within the page is above the threshold. Another rule may be that a page is marked complex if it exceeds an operator count threshold 854. Operator count threshold 854 may include an amount, such as a number of operators counted in one or more page objects, that causes the page to automatically be marked complex if the operators exceed the count.

Another rule may be that a page is marked complex if the number of drawing calls exceeds drawing calls threshold 856. Drawing calls threshold 856 may include a value, such as a number of drawing calls, within one or more page objects of the page. Examples of drawing calls include fill, stroke, text, image, and the like. If the number of drawing calls exceeds drawing calls threshold 856, then the page is automatically marked complex.

Starting pages rule 857 may refer to the situation where the initial starting pages equaling the number of RIPs within RIP system 110 always will be rendered. For example, if RIP system 110 includes 16 RIPs, such as RIP 400, then the first 16 pages of job 103 always are rendered and no complexity is determined for these initial pages. This feature allows some part of job 103 to be rendered, especially the first few pages that may be problematic. Such pages may include images or other objects that should be rendered.

Complexity rules 828 also may include complexity factors 858. A complexity factor may increase the assigned weight for a page object from complexity model 825 by a certain amount. For example, a complexity factor of 0.3 may increase a weight by 30%. Thus, a page object having a weight of 4.0 may be increased to 5.2 by application of the complexity factor. In other embodiments, the total page weight for the page may be multiplied by the complexity factor, which may be significant. If one of the conditions set forth in complexity rules 828 is met, then the appropriate complexity factor may be applied.

The data weight for a page object or a page increases by a spot color complexity factor 860 if a spot color is detected for an operation. For example, spot color 823 is determined to be used in third page object 822. This condition will cause the weight assigned to third page object 822 to be increased by spot color complexity factor 860. The data weight for a page object or page increases by a specific gradient complexity factor 862 if a specific gradient type is used. The weight for the page object or page will be increased by specific gradient complexity factor 862.

Further, the data weight increases by a specific image complexity factor 864 if a specific image type is detected in a page object. For example, the disclosed embodiments may already determine a specific image causes increased rendering time by print engine 260, but may not cause the page to automatically be complex. Other factors may allow the specific image to be rendered as a simple page. The data weight for the page object or the page increases by specific image complexity factor 864 if the specific image is used.

The data weight also may increase by a transparency complexity factor 866 is transparency is detected for an operation. The data weight for the page object having the operation increases by transparency complexity factor if transparency is detected.

Referring back to complexity rules 828, one rule may be that, for job 103 containing mostly complex pages, only a certain percentage of pages are rendered. Manager 302 will stop sending pages to RIP system 110 after a percentage threshold 868 is reached. In other words, after a certain percentage of pages in job 103 are rendered, or percentage threshold 868 is met, manager 302 will not render any further pages of job 103, even if some of the remaining pages are complex. For example, if percentage threshold 868 is 0.4, then manager 302 will stop sending pages to RIP system 110 if 40% of the pages of job 103 have been deemed complex and rendered. This feature may prevent storage 306 from being filled up with rendered pages of job 103 and not allow enough memory for current jobs being rendered.

Another threshold may be rendered pages threshold 870. Only a certain number of pages in job 103 are rendered to avoid excess resource usage, such as storage 306, and time competitiveness. Manager 302 will stop sending simple pages to RIP system 110 after rendered pages threshold 870 is met. Much like, percentage threshold 868, this feature seeks to prevent allocation of resources to a process and hold job.

Another threshold may be storage free space threshold 872. Manager 302 will stop sending simple pages to RIP system 100 if the disk free space falls below a value for free space threshold 872. Disk free space may refer to the amount of space available on storage 306. If storage 306 is 100 MB, then it may need 50 MB to perform rendering for current jobs and not delay processing to print engine 260. Storage free space threshold 872 may be 60 MB so if the available space at storage 306 falls below 60 MB, then manager 302 will stop sending complex pages of job 103 to RIP system 110.

Referring back to FIG. 8, complexity rules 828 may be applied by page weight determination engine 804. They also may be applied by page complexity determination engine 802. Application of complexity rules by page weight determination engine 804 may allow for a page to be determined complex without the need to determine page weight 806. For example, if page 605 includes a single image exceeding maximum image threshold 850, then the page is marked complex without the need to compare page weight 806 to base page weight 810.

Page complexity determination engine 802 applies the rule that a page is marked complex if page weight 806 exceeds base page weight 810. In some embodiments where scaled base page weight 816, the same determination is performed but using a scaled base page weight based on a scaled engine speed 814. For the disclosure below, base page weight may refer to base page weight 810 or scaled base page weight 816. If page weight 806 exceeds base page weight 810, then page 605 is marked complex and rendered by RIP system 110, unless cancelled by one of complexity rules 828.

In some embodiments, page complexity determination engine 802 may include page weight determination engine 804 within interpreter 402. Interpreter 402 may use a processor associated with RIP system 110 to enable the processes disclosed herein to determine page complexity.

In some embodiments, complexity levels may be assigned for pages so that they are provided the appropriate RIP instance in order to process the pages. Further, the numbers and types of RIPs configured for a job may be based on the amount of memory available and the number of renderers allocated for the RIPs. For example, RIP system 100 may have a finite resource pool that is managed by manager 302. RIP system 100 also may have a variable RIP pool, including failover RIPs that reduce the number of renderers in order to reduce the amount of memory needed to process one or more pages of a job.

In some embodiments, if page 605 is determined to be complex, then controller 106 or RIP system 110 may apply optimizations to the page. After page 605 is optimized using a process, the disclosed embodiments may evaluate the page again using the embodiments disclosed above to determine whether it is still complex. If so, then RIP system 110 may launch a RIP to render the complex page.

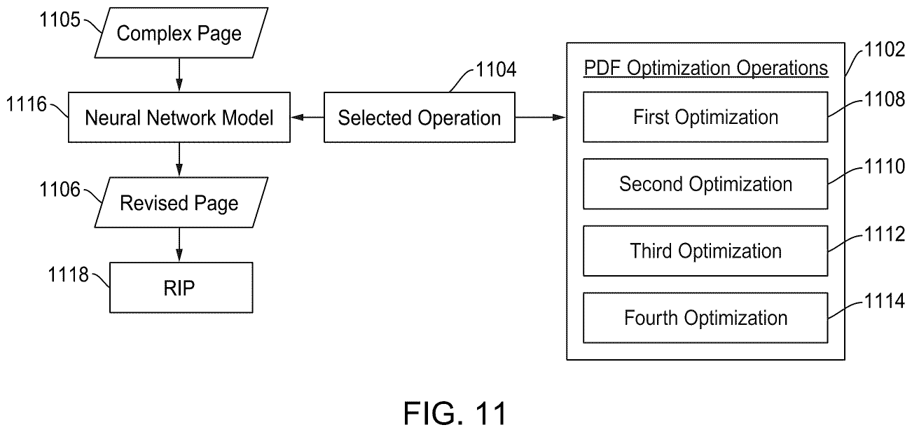

FIG. 11 depicts a block diagram of the application of a one of PDF optimization operations 1102 to a complex page according to the disclosed embodiments. Complex page 1105 may be page 605 that has been determined to be complex, as disclosed above. Controller 106 or RIP system 110 may select one of PDF optimization operations 1102 to apply to complex page 1105. This feature may be implemented outside RIP system 110 within controller 106.

For example, PDF optimization operations 1102 may include first optimization 1108, second optimization 1110, third optimization 1112, and fourth optimization 1114. Each optimization operation may relate to address a different issue within complex page 1105. First optimization 1108 may be an application of a lower resolution to objects within complex page 1105. The use of a lower resolution for rendering may reduce the need for a high performance or very high performance RIP to render the page. Complex page 1105 may be converted to a document having lower resolution to reduce the processing requirements to render the page.

Second optimization 1110 may relate to the user of a pre-rendered image for complex page 1105. An image or object within complex page 1105 that would require increased processing time to render would be replaced with a pre-rendered image using this operation. RIP system 110 may have access to the pre-rendered images in storage 306 or other storage within controller 106. This operation saves processing time as the image in complex page 1105 does not need to be rendered again.

Third optimization 1112 may relate to the flatness of a vector object or a transparency. This operation may reduce the amount of flatness needed for reproducing the vector object. For example, the number of lines uses to flatten a vector object may be reduced, which also reduces the processing needs to render the vector object. Transparency may be refer to the process of converting a vector graphic with transparent elements into a single, solid image by merging overlapping areas and removing transparency to eliminate any complex layering or opacity variations. Third optimization 1112 may reduce the amount of flatness or transparency used to render objects within complex page 1105.

Fourth optimization 1114 may relate to the use of an embedded font. Certain fonts may increase the processing requirements for rendering the fonts. This operation may use an embedded font to remove the need to process an unusual or processing intensive font. Other operations may be implemented by PDF optimization operations 1102 but not disclosed herein. Controller 106 or manager 302 of RIP system 110 may analyze complex page 1105 to determine which operation to select. The operation also may be selected using a trained neural network model 1116. This process is disclosed in greater detail below.

Neural network model 1116 may evaluate complex page 1105 and determine a selected operation 1104 of the PDF optimization operations 1102 to apply to the complex page. Controller 106 may apply the operation to generate a revised page 1106. Revised page 1106 should be optimized in order to reduce the processing requirements so that the page is not complex according to the complexity criterion, such as page weight. Revised page 1106 may be evaluated for complexity as disclosed above. If revised page 1106 is still complex, then RIP system 110 may launch a new RIP having increased renderers, as disclosed above, to render the revised page. Alternatively, revised page 1106 may be provided to neural network 1116 to apply another optimization operation.

Revised page 1106 is provided to a RIP 1118. If revised page 1106 is not complex, then RIP 1118 may be a standard RIP, such as RIP instance 500A disclosed above. If revised page 1106 is still complex, then RIP 1118 may be a high performance RIP or a very high performance RIP, such as RIP instance 500B disclosed above. Manager 302 may be instructed to reconfigure and launch a new RIP to process revised page 1106.

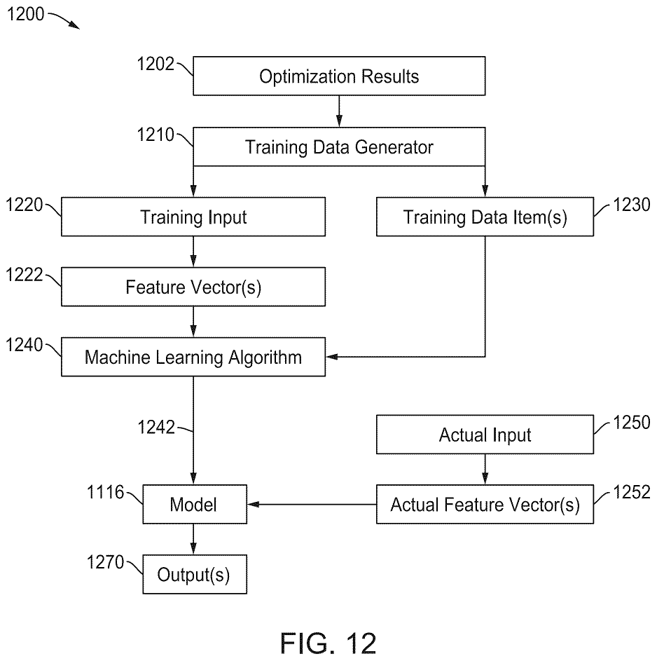

FIG. 12 depicts a block diagram of a supervised learning pipeline 1200 for a neural network model 1116 to select an optimization operation according to the disclosed embodiments. Model 1116 may pertain to a model trained to select a PDF optimization operation to generate revised page 1106 from complex page 1105. Model 1116 is generated and trained using supervised learning pipeline 1200.

Supervised learning pipeline 1200 includes training data generator 1210, training input 1220, one or more feature vectors 1222, one or more training data items 1230, machining learning algorithm 1240, actual input 1250, one or more actual feature vectors 1252, model 1116, and one or more predictive date field outputs 1270. Part or all of supervised learning pipeline 1200 may be implemented by executing software for part or all of supervised learning pipeline 1200. These operations may occur within controller 106 of printing device 104. They also may occur elsewhere within printing system 100, such as print management server 108.

In operation, supervised learning pipeline 1200 may involve two phases: a training phase and a prediction phase. The training phase may involve machine learning algorithm 1240 learning one or more tasks related to selecting an optimization operation to apply to complex page 1105. The prediction phase may include model 1116, which is a trained version of machine learning algorithm 1240 and makes predictions to accomplish one or more tasks for determining features along with probability scores for operations to select. In some embodiments, machine learning algorithm 1240 or model 1116 may include one or more artificial neural networks (ANNs), deep neural networks, convolutional neural networks (CNNs), recurrent neural networks, support vector machines (SVMs), Bayesian networks, genetic algorithms, linear classifiers, non-linear classifiers, algorithms based on kernel methods, logistic regression algorithms, linear discriminant analysis algorithms, or principal components analysis algorithms.

During the application of PDF optimization operations 1102 to complex pages 1105, controller 106 or server 108 may capture the results in generating revised page 1106, including whether revised page 1106 is still complex. These results may be known of optimization results 1202 compiled within printing system 100. Effectiveness of the different operations may be captured. The effectiveness of an optimization operation may be determined by comparing the rendering time from complex page 1105 to the rendering time of revised page 1106. Any increase or decrease in the rendering time is captured. This information may be used as training input 1220 by supervised learning pipeline 1200.

During the training phase of supervised learning pipeline 1200, training data generator 1210 may generate training input 1220 and training data item(s) 1230 using optimization results 1202. Training input 1220 may be processed to determine one or more feature vectors 1222 based on optimization results 1202. In some embodiments, training input 1220 may be preprocessed. For example, for each result of an optimization operation applied to a complex page 1105, training input 1220 may be preprocessed to the effectiveness in reducing processing requirements for the complex page. The tables, factors, scores, attributes, strategies, results, and the like may be used as part of training input 1220. In some embodiments, training data generator 1210 is not used to generate training input 1220 or training data items(s) but optimization results 1202 are provided directly as feature vectors 1222.

Feature vector(s) 1222 may be provided to machine learning algorithm 1240 to learn one or more tasks for selecting an optimization operation to reduce the complexity of a page being rendered by RIP system 110. After performing the one or more tasks, machine learning algorithm 1240 may generate one or more outputs 1242 based on feature vector(s) 1222 and, optionally, training data items 1230. Output 1242 may be a prediction or score of which optimization operation to select from PDF optimization operations 1102.

During training, training data items 1230 may be used to make an assessment of the outputs 1242 of machine learning algorithm 1240 for accuracy. Machine learning algorithm 1240 may be updated based on this assessment. Training of machine learning algorithm 1240 is considered to be trained to perform the one or more tasks for providing a probability for an optimization operation to be applied. Once trained, machine learning algorithm 1240 may be used to generation model 1116. In other words, model 1116 may be generated from the training of machine learning algorithm 1240. In some embodiments, machine learning algorithm 1240 also is known as a model.

During the prediction phase of supervised learning pipeline 1200, actual input 1250 may be used to generate one or more actual feature vectors 1252. In some embodiments, some of all of actual input 1250 includes one or more forms of data disclosed above. Actual input 1250 may be provided to model 1116 via actual feature vector(s) 1252. Model 1116 may generate one or more outputs, such as predictions or probabilities, based on actual input 1250. The outputs of model 1202 may be provided as outputs 1270. Outputs 1270 are used to select an optimization operation to apply to complex page 1105. Actual input 1250 may be based a new complex page 1105 being processed by model 1116 that is then used to select an optimization operation as output 1270.

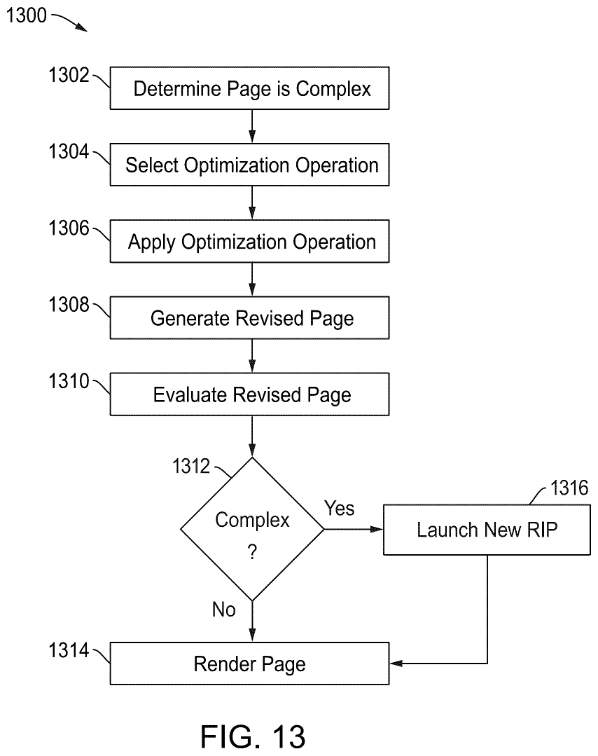

FIG. 13 depicts a flowchart 1300 for applying an optimization operation to a complex page 1105 according to the disclosed embodiments. Flowchart 1300 may refer to FIGS. 1-12 for illustrative purposes. Flowchart 1300, however, is not limited to the embodiments disclosed by FIGS. 1-12.

Step 1302 executes by determining page 605 is a complex page 1105, as disclosed above. Step 1304 executes by selecting an optimization operation from PDF optimization operations 1102 using neural network model 1116 based on the properties of complex page 1105. Neural network model 1116 may receive an actual feature vector 1252 generated for complex page 1105. Using the result of model 1116, an operation is selected.

Step 1306 executes by applying selected operation 1104 to complex page 1105, similar to PDF optimization operations. Selected operation 1104 may be applied by controller 106 or server 108 within printing system 100. Step 1308 executes by generating revised page 1106 having the optimization applied to its content. Revised page 1106 also may be referred to as an optimized page. Step 1310 executes by evaluating revised page 1106 to determine if it is complex using the complexity determination operations disclosed above.

Step 1312 executes by determining whether revised page 1106 is complex. If no, then step 1314 executes by rendering revised page 1106 within RIP system 110. The results of the optimization operation applied to the type of complex page 1105 and the resulting revised page 1106 may be captured to be provided to model 1116 for training.

If step 1312 is yes, then step 1316 executes by launching a new RIP configured to render complex pages, as disclosed above. Manager 302 may reconfigure an existing RIP to have additional renderers to process revised page 1106. Flowchart 1300 proceeds to step 1314 to render revised page 1106. The results of the optimization operation applied to the type of complex page 1105 and the resulting revised page 1106 that is still complex is captured to further train model 1116. Alternatively, the disclosed embodiments may provide revised page 1106 to model 1116 to select a second optimization operation to apply to the page and repeat this process until a revised page is not considered complex.

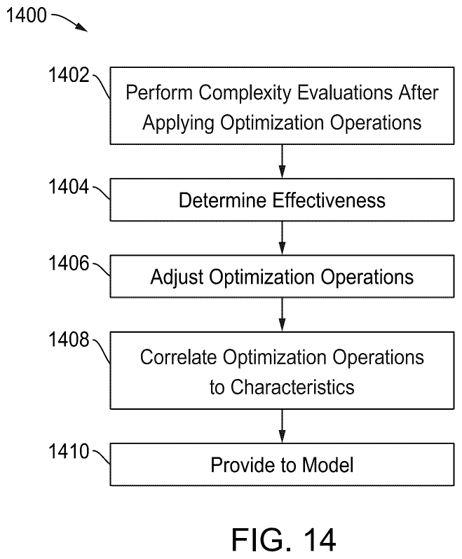

FIG. 14 depicts a flowchart 1400 for evaluating and adjusting PDF optimization operations 1102 according to the disclosed embodiments. Flowchart 1400 may refer to FIGS. 1-13 for illustrative purposes. Flowchart 1400, however, is not limited to the embodiments disclosed by FIGS. 1-13.

Step 1402 executes by performing complexity evaluations after applying the various PDF optimization operations to a complex page 1105. The disclosed embodiments may apply each optimization operation to the complex page and determine its effectiveness in reducing the rendering time. For example, first optimization 1108 may be applied to complex page 1105 and reduce rendering time by T1. Second optimization 1110 may be applied to complex page 1105 and reduce rendering time by T2. Third optimization 1112 may be applied to complex page 1105 and reduce rendering time by T3. Fourth optimization 1114 may be applied to complex page 1105 and reduce rendering time by T4.

Step 1404 executes by determining the effectiveness of the various optimization operations in reducing rendering time for complex page 1105. For example, it may be determined that T2>T3>T1>T4. Thus, fourth optimization 1114 may be the least effective operation to optimize complex page 1105. Further, step 1404 may evaluate with the revised page from each optimization operation is still complex. If so, then the respective optimization operation is not effective.

Step 1406 executes by adjusting PDF optimization operations 1102 to remove those operations that are not effective in optimizing complex page 1105. For example, fourth optimization 1114 may be removed or not applied when a complex page similar to complex page 1105 is received at model 1116. Step 1408 executes by correlating PDF optimizations to specific PDF characteristics. Certain characteristics may be found in complex page 1105 and the optimization operations effective in reducing the complexity of the page may be correlated. For example, based on T2 and T3, second optimization 1110 and third optimization 1112 correlate to the characteristics of complex page 1105. Step 1408 executes by providing this information to train model 116.

Thus, the disclosed embodiments provides benefits versus the usual process of applying PDF optimizations to every job or to jobs that are identified via preflight. The disclosed embodiments minimize changes that errors are introduced into the job because PDF optimizations are applied only to pages that are deemed complex as opposed to potentially applying them to all pages. The disclosed embodiments improve performance by applying optimization to individual PDF pages. The disclosed embodiments also improve performance by continually improving its ability to determine when it makes sense to apply PDF optimizations. The disclosed embodiments also improve performance by determining which specific optimizations should be applied to which document pages.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for optimizing printing operations, the method comprising:
determining a page of a print job is complex;
applying at least one optimization operation to the page; and
generating an optimized page from the page and the at least one optimization operation.

2. The method of claim 1, further comprising evaluating whether the optimized page is complex according a complexity criterion.

3. The method of claim 2, further comprising, if the optimized page is still complex, processing the optimized page using a specially configured raster image processor (RIP).

4. The method of claim 1, further comprising training a neural network with the page, the at least one optimization operation, and the optimized page.

5. The method of claim 4, wherein the at least one optimization operation includes a plurality of optimization operations.

6. The method of claim 5, further comprising removing an optimization operation from the plurality of optimization operations prior to training the neural network.

7. The method of claim 4, further comprising applying the trained neural network to a subsequent page.

8. The method of claim 7, further comprising determining at least one preferred optimization operation for the subsequent page using the trained neural network.

9. The method of claim 1, wherein the at least one optimization operation includes at least one of an application of a lower resolution, use of a pre-rendered image, flatness of a vector object or a transparency, and use of an embedded font.

10. The method of claim 1, wherein the optimized page has a lower processing overhead than the page.

11. A method for training a neural network to optimize printing operations, the method comprising:
applying at least one optimization operation to a complex page of a print job;
generating an optimized page from the complex page and the at least optimization operation;
training the neural network with the complex page, the at least one optimization operation, and the optimized page, wherein the neural network is trained to apply the at least one optimization operation to a subsequent complex page.

12. The method of claim 11, wherein the at least one optimization operation includes a plurality of optimization operations.

13. The method of claim 12, further comprising
applying a first optimization operation of the plurality of optimization operations to the complex page; and
evaluating whether the optimized page is complex after application of the first optimization operation.

14. The method of claim 13, further comprising removing the first optimization operation from the plurality of optimization operations to train the neural network if the optimized page is complex.

15. The method of claim 13, further comprising applying a second optimization operation of the plurality of optimization operations to the complex page after the application of the first optimization operation.

16. A method for optimizing printing operations at a printing device, the method comprising:
determining a page of a print job is complex;
applying at least one optimization operation to the page;
generating an optimized page from the page and the at least one optimization operation;
training a neural network with the page, the at least one optimization operation, and the optimized page;
applying the trained neural network to a subsequent page to identify the at least one optimization operation for a subsequent page similar to the page; and
optimizing the subsequent page with the at least one optimization operation.

17. The method of claim 16, wherein the at least one optimization operation includes a plurality of optimization operations.

18. The method of claim 16, further comprising evaluating whether the optimized page is complex according a complexity criterion.

19. The method of claim 18, further comprising, if the optimized page is still complex, processing the optimized page using a specially configured raster image processor (RIP).

20. The method of claim 19, wherein training the neural network includes training the neural network with the processed optimized page and the specially configured RIP.
